(19) United States
(12) Patent Application Publication
(10) Pub. No.: US 2022/0107777 A1
(43) Pub. Date: Apr. 7, 2022

(54) CONTENT FIDELITY ADJUSTMENT BASED ON USER INTERACTION

(71) Applicant: Intel Corporation, Santa Clara, CA (US)

(72) Inventors: Aleksander Magi, Portland, OR (US); David W. Browning, Portland, OR (US); Arvin Kumar, Beaverton, OR (US)

(21) Appl. No.: 17/553,329

(22) Filed: Dec. 16, 2021

(51) Int. Cl. G06F 3/14; G06F 3/01; G06F 3/16

(52) U.S. Cl. CPC G06F 3/1462; G06F 3/012; G06F 3/16; G06F 3/013

(57) ABSTRACT

Methods, apparatus, systems, and articles of manufacture are disclosed for content fidelity adjustment based on user interaction. An example apparatus includes processor circuitry to execute the instructions to: determine, based on user interaction, a region of focus on a display presenting a plurality of microservices; identify a first set of the microservices presented in the region of focus; present the first set of the microservices with a first quality level; identify a second set of the microservices presented outside of the region of focus; and present the second set of the microservices with a second quality level, the second quality level lower than the first quality level.

### FIELD OF THE DISCLOSURE

This disclosure relates generally to rendering content on electronic devices and, more particularly, to content fidelity adjustment based on user interaction.

### BACKGROUND

Workspaces such as online digital whiteboard collaboration tools present multiple types of content on displays to multiple users. Users typically focus on one region of the workspace at a time.

### BRIEF DESCRIPTION OF THE DRAWINGS

FIG. 1A is a block diagram of an example system for providing example workspaces to example client devices over a network.

FIG. 1B is a block diagram of the example system of FIG. 1A for content fidelity adjustment based on user interaction in accordance with the teachings of this disclosure.

FIG. 2 is an illustration of an example display showing a workspace.

FIG. 3 is an illustration of an example display showing a workspace with adjusted content fidelity.

FIG. 4 is a flowchart representative of example machine readable instructions and/or example operations that may be executed by example processor circuitry to implement the example content fidelity adjustment circuitry and the example client electronic device of FIG. 1B.

FIG. 5 is a block diagram of an example processing platform including processor circuitry structured to execute the example machine readable instructions and/or the example operations of FIG. 4 to implement the content fidelity adjustment circuitry of FIG. 1B.

FIG. 6 is a block diagram of an example processing platform including processor circuitry structured to execute the example machine readable instructions and/or the example operations of FIG. 4 to implement the client electronic device of FIG. 1B.

FIG. 7 is a block diagram of an example implementation of the processor circuitry of FIG. 5 and/or FIG. 6.

FIG. 8 is a block diagram of another example implementation of the processor circuitry of FIG. 5 and/or FIG. 6.

FIG. 9 is a block diagram of an example software distribution platform (e.g., one or more servers) to distribute software (e.g., software corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Workspace providers supply or support services and applications including, for example, cloud-based applications to enable a plurality of users to edit or share work and other content in a collaborative whitespace or environment. This format is the digital version of an in-person project room and can provide a greater level of alignment on chronological order and hierarchy of information. In some instances, there are a number of challenges for rendering high quality content for the user and their collaborators to edit and share in real-time. For example, the size and complexity of the applications lend to a relatively larger risk of lagging content based on bandwidth affordances. Some efforts to reduce bandwidth constraints also reduce the fidelity of the content presented via the application.

With these types of collaboration spaces, the user will focus, hover, and/or interact with specific spaces or panels of content of the collaboration page or room. For the content that the user might not be looking at or interacting with, the content does not have to be updated and/or refreshed in real time. In addition, content that the user is not interacting with does not have to be at the highest resolution. In some examples, the workspace includes a plurality of windows of content where one, more, and/or each of the windows is served from a cloud construct or other network, and one, more, and/or each window can be its own microservice with its own cloud resource pool. Windows that are not being actively focused on, hovered overed, and/or otherwise interacted with can drop to a lower refresh-rate, or resolution, or color bit depth. This content, thus, is allowed to reduce their required quality of service (QoS) guarantee. On the other hand, in some examples, the applications or other content that are actively being viewed or interacted with are to serve a full and complete experience with a relatively higher QoS. In some examples, the content of active engagement is served with the highest QoS possible. With different QoS delivered for different content, the bandwidth served from the cloud configuration or other network configuration has different dynamic content aspects depending on where the user is focused.

The examples disclosed herein improve the user experience by leveraging user interaction data including user action patterns and behavior to intelligently optimize shared workspaces including workspaces presented by cloud-based services. In some examples, the user-attentiveness or interaction data is collected and passed to the cloud services. Those microservices or other content that are within the user's focus region will be at the higher QoS than content outside of the focus region. The user interaction data is dynamically used to reduce bandwidth requirements and perceived lag of content loading while maintaining content fidelity. In the examples disclosed herein, user interaction data is used to reduce the pipeline of data transmitted from the workspace provider to the client device. In some examples, the workspace provider prioritizes bandwidth for delivery of content on which the user is focused with high quality to preserve its fidelity while content on which the user is not focused is delivered with a lower quality, which affects its fidelity. For example, if the workspace includes multiple applications or microservices, the workspace provider may send high quality data to the client device for the microservice on which the user is focused. In such examples, lower quality data or less data may be transmitted for microservices on which the user is not focused. The microservice on which the user is focused has a high fidelity and may appear larger, full-screen, clearer, louder, etc. One the other hand, the microservices on which the user is not focused has lower fidelity and may appear frozen, delayed, pixelated, in soft focus or out of focus entirely, muted, etc. By passing the user interaction information back to the server, a symbiotic cloud/client relationship can form where the cloud server(s) are only serving content of interest to the client end-user. In some examples, to improve the bandwidth even further, a lower resolution instance of the focused microservices or other content can be provided with the client applying a super-resolution effect to the content in the region of focus.

As used herein, “content” is used to describe any type of audio and/or visual graphics, texts, images, sounds, and/or other types of media that may be presented through an electronic device. Content includes applications, programs, panels, services, microservices, and components thereof.

As used herein “fidelity” and “quality” maybe used interchangeably to describe a condition of the content. The fidelity or quality of the content is based on factors such as, for example, completeness, transmission rates, refresh rates, etc.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

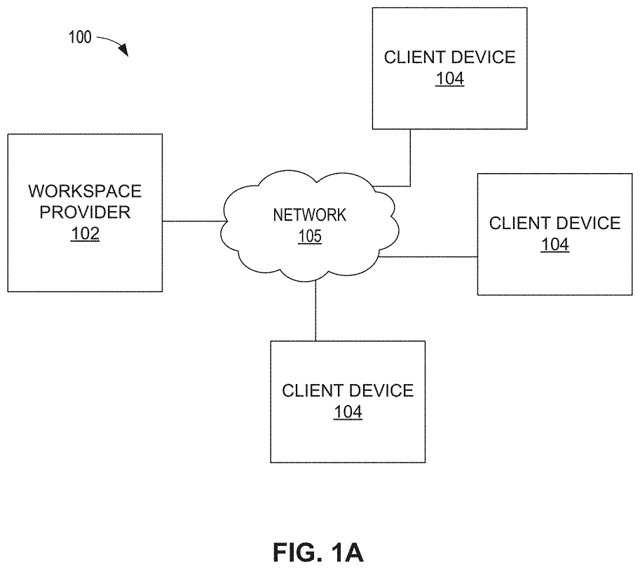

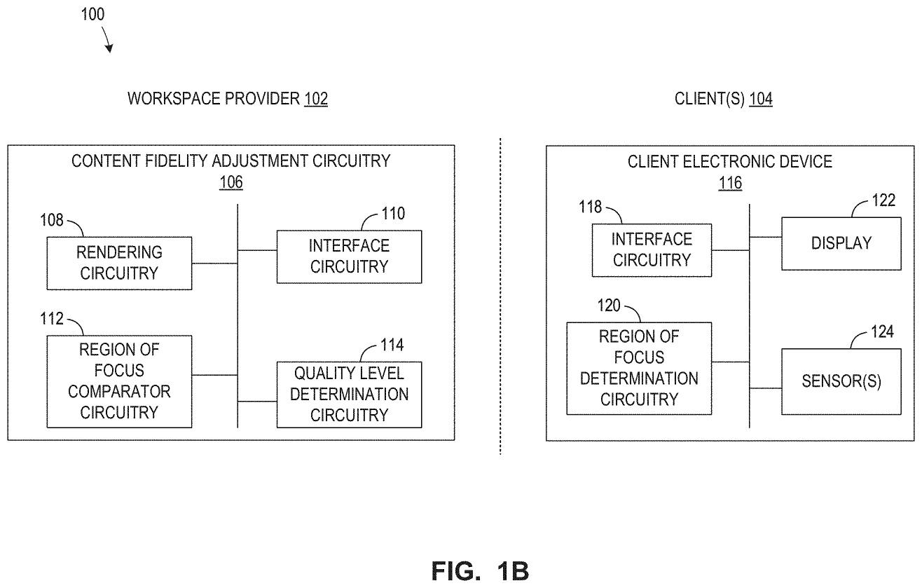

FIG. 1A is a block diagram of an example system 100 for providing example workspaces from an example workspace provider 102 to one or more example client devices 105 over an example network 105. The example system 100 may be used for content fidelity adjustment based on user interaction in accordance with the teachings of this disclosure.

The workspace provider 102 provides workspaces, microservices, apps, programs, and/or other types of content over the network 105 for consumption by the client devices 104. The client devices 104 may be any computing devices, such as for example, a desktop personal computer, a laptop, a tablet computer, a smartphone, a wearable device, etc.

The interaction between the client devices 104 and the workspace provider take place via the network 105. In some examples, the network 105 is the Internet, an intranet, a wide area network, a local area network, a personal area network, and/or some combination thereof. In some examples, the workspace provider 102 implements a cloud content sharing service. In some examples, the cloud-based service is part of an example cloud computing architecture that includes a front end component and a back end component. The front end component is seen by the client device 104 via, for example, a web browser to access the internet or other interface. In some examples, the back end component of the example cloud computing architecture includes processers, servers, and data storage devices.

FIG. 1B is a block diagram of the example system 100 showing further details of the example workspace provider 102 and the example client 104. In some examples, there is more than one client, as shown in FIG. 1A. The workspace provider 102 provides content that is transmitted to, received by, and/or accessed by the client 104.

The workspace provider 102 and the client 104 of FIG. 1B may be instantiated (e.g., creating an instance of, bring into being for any length of time, materialize, implement, etc.) by processor circuitry such as a central processing unit executing instructions. Additionally or alternatively, the workspace provider 102 and the client 104 of FIG. 1B may be instantiated (e.g., creating an instance of, bring into being for any length of time, materialize, implement, etc.) by an ASIC or an FPGA structured to perform operations corresponding to the instructions. Therefore, some or all of the circuitry of FIG. 1B may be instantiated at the same or different times. Some or all of the circuitry may be instantiated, for example, in one or more threads executing concurrently on hardware and/or in series on hardware. Moreover, in some examples, some or all of the circuitry of FIG. 1B may be implemented by one or more virtual machines and/or containers executing on the microprocessor.

In the illustrated example, the workspace provider 102 includes example content fidelity adjustment circuitry 106. The content fidelity adjustment circuitry 106 includes example rendering circuitry 108, example interface circuitry 110, example region of focus comparator circuitry 112, and example quality level determination circuitry 114. In the illustrated example, the client 104 include example interface circuitry 118, example regions of focus determination circuitry 120, an example display 122, and one or more example sensors 124.

The workspace provider 102 provides a workspace for the client 104. The rendering circuitry 108 constructs and renders a workspace for transmission via the interface circuitry 110 to the client 104 and display at the display 112 of the client electronic device 116. In some examples, the workspace is rendered and transmitted to multiple client electronic devices 116. In some examples, the different client electronic devices 116 show the same workspace including, for example, when the users of the respective client device 116 are working in collaboration. In some examples, some client electronic devices 116 show the same portions of a workspace while their individual displays 112 include other portions of a workspace that are different. In other words, a client 104 may have a first subset of the content of a workspace shared with another client 104 for a collaboration while a second subset of the workspace is different than that of the other client 104 for work or other projects that are not collaborative and/or are collaborative with other people.

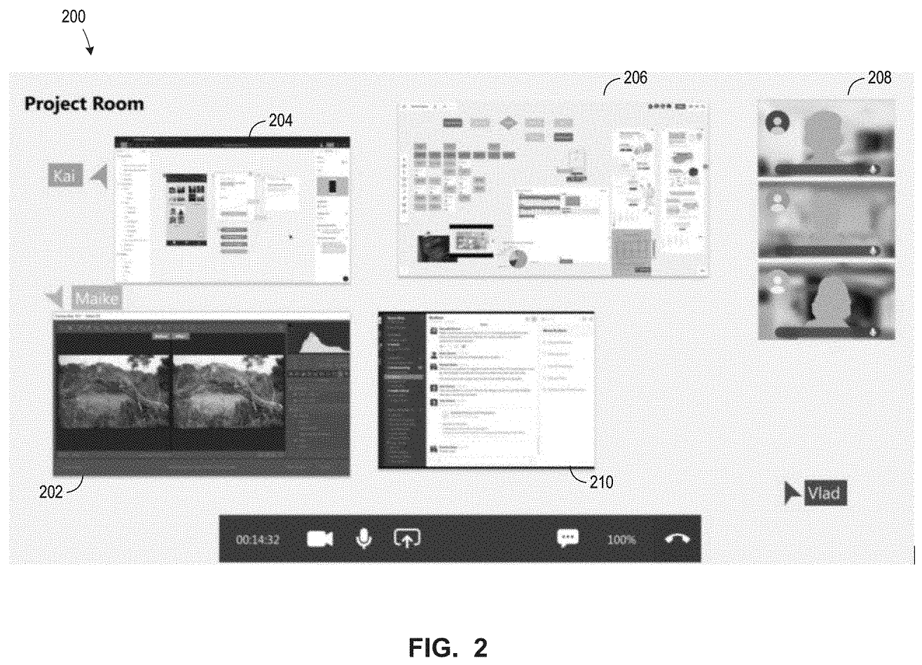

An example workspace 200 is shown in FIG. 2. The workspace 200 includes different windows or areas of content 202, 204, 206, 208, 210. In the example of FIG. 2, there are five areas of content 202, 204, 206, 208, 210 with five different types of content. In other examples, there may be fewer or more areas of content and/or different content in the areas of content 202, 204, 206, 208, 210. In addition, during the use of the workspace the number of areas and/or the type of content may change. The example workspace of FIG. 2 resides on a cloud-based server, and the respective areas of content within the workspace 200 are cloud-based microservices. In the illustrated example workspace, the first area of content 202 includes Adobe Lightroom, the third area of content 206 includes a Miro board, the fourth area of content 208 includes a Teams project-room chat, and the other areas of content 202, 210 include other tools. Other tools include, for example, FIGMA, Bluescape, Mural, Trello, other digital and/or virtual collaboration platforms, and/or other cloud-based applications including, for example, Adobe Creative Cloud. These respective tools or content areas are separate microservices. In some examples, at the initial serving, that is when the rendering circuitry 108 first renders the workspace 200, each service initializes at their highest QoS to ensure the user can have immediate access to whichever elements interest them.

The interface circuitry 118 of the client electronic device 116 receives, obtains, and/or accesses the workspace constructed and rendered by the rendering circuitry 108. The display 122 presents the workspace to the client 104.

One or more sensors 124 of the client electronic device 116 gather data from the client's use of the client electronic device 116. For example, the one or more sensors 124 includes sensors that gather data related to a user's actions and/or behaviors that indicate user interaction with the electronic device. The sensors can include a microphone, a camera, an infrared sensors, an eye gaze tracker, an optical sensor, a strain gauge, circuitry to detect operations of the client electronic device 116, a capacitive sensor, and/or other types of sensors or combinations of sensors. The activity and behavior detected by the one or more sensors 124 include, for example, user presence at the client electronic device 116, a head position, an eye gaze, a touch on a screen, a touch on a trackpad, a hover of a cursor, a movement of a mouse, a click, a grasp of a stylus, a key stroke, a voice stream, a verbal command, a position of a display panel, an operating status of an application or program, a zoom in or out, and/or other interactions with the client electronic device 116.

The region of focus determination circuitry 120 determines a region of focus on the display 122 based on the user interaction data gathered by the one or more sensors 124. The workspace 200 presented on the display 122 includes a plurality of content. In some examples, the workspace 200 includes a plurality of microservices. In some examples, the region of focus determination circuitry 120 identifies first content including, for example, a first set of the microservices presented in the region of focus and identifies second content including, for example, a second set of the microservices presented outside of the region of interest.

Additionally or alternatively, the client electronic device 116 transmits the data related to or indicative of the region of focus to the content fidelity adjustment circuitry 106. In some examples, the region of focus comparator circuitry 112 receives, access, or obtains notification of the region of focus on the display 122 of the client electronic device 116 presenting the workspace. In some examples, the region of focus comparator circuitry 112 identifies first content including, for example, a first set of the microservices presented in the region of focus and identifies second content including, for example, a second set of the microservices presented outside of the region of interest. Thus, content within the region of focus and content outside of the region of focus may be determined or identified locally at the client 104 or remotely at the workspace provider 102.

Based on the region of focus, the quality level determination circuitry 114 sets a first quality level for first content in the region of focus and sets a second quality level for second content outside of the region of interest, the second quality level lower than the first quality level. In some examples, the rendering circuitry 108 initially renders the entire workspace at a relatively higher quality level, as disclosed above. In such examples, all aspects of the workspace may appear clear and intelligible to the user. In other examples, the rendering circuitry 108 initially renders the workspace with a relatively lower quality level. Other examples may include a combination of quality levels in the initial rendering of the workspace. With client feedback regarding the region of focus, and the set quality levels determined by the quality level determination circuitry 114, the rendering circuitry 108 renders the workspace as an adjusted workspace with the first quality level and the second quality level. The content fidelity adjustment circuitry 106 transmits the adjusted workspace to the client 104 via, for example, the interface circuitry 110.

In some examples, the content fidelity adjustment circuitry 106 transmits a first amount of data to transmit the initial workspace and transmits a second amount of data to transmit the adjusted workspace that has been adjusted based on the region of focus. In some examples, when the initial rendered workspace includes all the content at a relatively high quality, the second amount of data transmitted with the adjusted workspace is less than the first amount of data transmitted with the initial workspace. In other examples, when the initial rendered workspace includes all the content at a relatively low quality, the second amount of data transmitted with the adjusted workspace is greater than the first amount of data transmitted with the initial workspace.

There are many parameters that may be adjusted by the content fidelity adjustment circuitry 106. For example, the quality level may be a sharpness or focus where the higher quality level is in focus and the lower quality level is out of focus. In some examples, the quality level is a size of the content window where the higher quality level is a larger window, and the lower quality level is a smaller window. In some examples, the quality level is a rate at which the content is downloaded or refreshed, and the higher quality level is a first refresh rate and the second quality level is a second refresh rate, the second refresh rate less frequent than the first refresh rate. In some examples, the quality level is a frame rate at which the content is presented, and the higher quality level is a first frame rate and the second quality level is a second frame rate, the second frame rate less than the first frame rate. In some examples, the first frame rate is 24 frames per second. In some examples, the quality level is a volume, where the higher quality level is a louder or an audible volume and the lower quality level is a quieter volume or mute. In some examples, the quality level is a brightness, and the higher quality level is brighter than the lower quality level.

The display 122 of the client electronic device 116 presents content (e.g., a first set of microservices) in the region of interest with a higher quality level as rendered by the rendering circuitry 108 in accordance with the quality level determination circuitry 114. The display 122 of the client electronic device 116 presents content (e.g., a second set of microservices) outside of the region of interest with a lower quality level as rendered by the rendering circuitry 108 in accordance with the quality level determination circuitry 114.

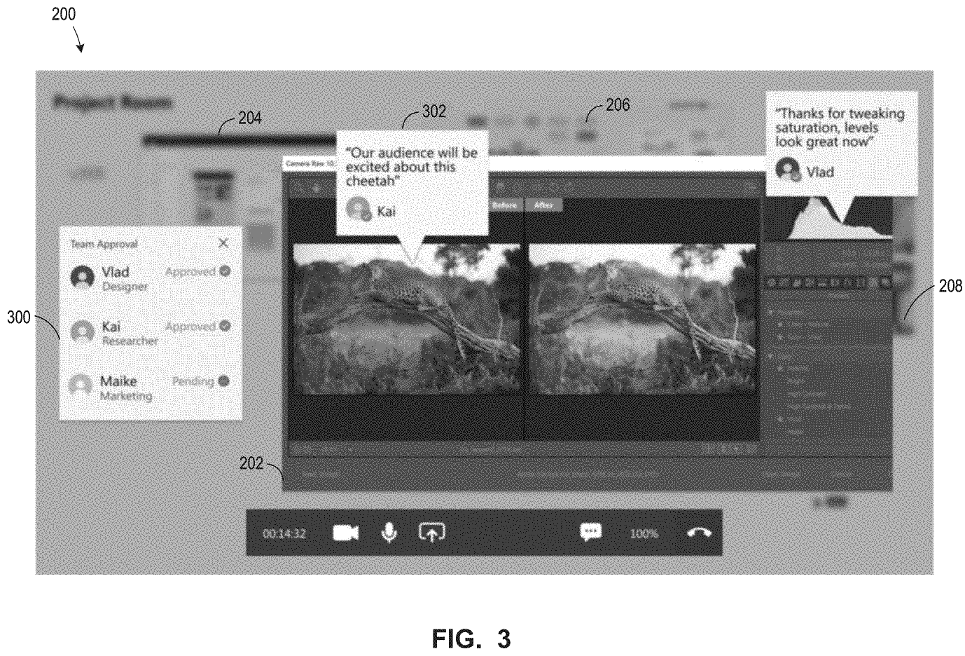

FIG. 3 illustrates the workspace 200 with adjusted fidelity based on a region of focus. In this example, the viewer of the workspace 200 focused on the area of content 202. In other works, in the illustrated example, the Adobe Lightroom application has become the region of focus. The quality level determination circuitry 114 determined that the higher quality level of the area of content 202 is a clearer focus and larger footprint on the display 122. The rendering circuitry 108 reconstructed the workspace 200 such that the area of content 202 would appear clearer and larger. In addition, with the area of content 202 in the region of focus, additional or supplemental content 300, 302 related to the application in the rea of content 202 appears.

The quality level determination circuitry 114 determined that the areas of content 204, 206, 208, 210 outside of the region of focus should appear out of focus and/or partially or fully obscured. The rendering circuitry 108 reconstructed the workspace 200 such that the areas of content 204, 206, 208, 210 would appear at the lower quality. In other words, the QoS for the other microservices in the areas of content 204, 206, 208, 210 are reduced, allowing these services and the client 104 to save power and bandwidth transmitted to the client 104.

The region of focus determination circuitry 120 continues to monitor data from the sensor(s) 124 to identify changes in a user's region of focus. The region of focus comparator circuitry 112 compares details of the region of focus to determine when there are changes in the region of focus. A change in the region of focus prompts reassessment of what quality levels of the different content in the workspace is to be presented and re-rendering of the content in accordance with the updated quality levels. Thus, the quality levels of the different areas of content change over time as the user's focus changes throughout the workspace. For example, if the user continues to focus on the area of content 202, the workspace may remain with the quality levels shown in FIG. 3. However, when the user is done working with the application in the area of content 202, that is when the user begins to zoom out of or close Adobe Lightroom in this example, the region of focus changes. When the region of focus changes, the other microservices are awakened, and a new workspace quality level distribution is served to the client 104 as disclosed further herein.

In some examples, the region of focus determination circuitry 120 performs a confirmation of the change from in the region of focus after an amount of time. In such examples, the region of focus determination circuitry 120 prevents transmission of a notification of a change in the region of focus when the change in the region of focus does not last for at least a minimal or threshold amount of time. The region of focus determination circuitry 120 enables or otherwise allows transmission of a notification of a change in the region of focus when the change in the region of focus satisfies at least the minimal or threshold amount of time. In some examples, the region of focus comparator circuitry 112 performs a confirmation of the change from in the region of focus after an amount of time. In such examples, the region of focus comparator circuitry 112 prevents redetermination of quality levels and re-rendering of the workspace when the change in the region of focus does not last for at least a minimal or threshold amount of time. In addition, the region of focus comparator circuitry 112 enables or otherwise allows redetermination of quality levels and re-rendering of the workspace when the change in the region of focus satisfies the minimal or threshold amount of time. In these examples, the system 100 for content fidelity adjustment prevents changes in the workspace based on relatively minor or fleeting changes in focus such as, for example, if the user momentarily looks away from the display 122.

In some examples, the workspace provider 102 transmits the workspace to a plurality of clients 104. Different ones of the client devices 104 may have different regions of focus. In such examples, first content on a first client electronic device may be presented at a higher quality, and second content on a second client electronic device different than the first content may be presented at a higher quality. In such examples, the workspace provider 102 transmits workspaces with different types of content presented at different quality levels to different clients 104. Also, in some examples, the quality levels of the different content on the different client electronic devices may shift asynchronously depending on the specific client's region of focus. In some examples, there may be multiple clients viewing the same workspace but with different regions of focus. In such examples, the QoS for each application or microservice is only reduced if that application or microservice is within none of the regions of focus for any of the clients.

In other examples, different ones of the clients 104 may have the same regions of focus. For example, multiple clients may collaborate in a workspace and conduct a video conference. In such examples, first content on a first client electronic device may be presented at a higher quality, and second content on a second client electronic device, which is the same as the first content on the first user device, also is presented at the higher quality. In such examples, the workspace provider 102 transmits workspaces with the same content presented at the same relatively higher quality level to the different clients 104.

In some examples, the content fidelity adjustment circuitry 106 causes an adjusted workspace to be rendered based on a time of day. For example, a client 104 may have a calendar entry that indicates a meeting start time. In this example, the content fidelity adjustment circuitry 106 causes the rendering circuitry 108 to render the workspace with the program or application via which the meeting is to be attended to be presented at a higher quality (e.g., larger on the display 122 and in clearer focus) when the meeting time approaches.

In some examples, bandwidth requirements are reduced by implementing super resolution at the client 104. For examples, videos and/or images may be upscaled by the client electronic device 116 based on the region of focus. Thus, the rendering circuitry would not have to implement super resolution of any content before the content fidelity adjustment circuitry 106 transmits the workspace. Rather, the enhanced super resolution can occur on the client side and save bandwidth during transmission of the workspace.

The examples may also be applied to other compute-focused tasks. For example, microservices that include real time artificial intelligence inferencing requirements may implement the teachings of disclosure. For example, an application that implements face beautification may cause the beautification processes to stop while the microservice is outside of a region of focus.

While an example manner of implementing the workspace provider 102 and client 104 are illustrated in FIG. 1B, one or more of the elements, processes, and/or devices illustrated in FIG. 1B may be combined, divided, re-arranged, omitted, eliminated, and/or implemented in any other way. Further, the example content fidelity adjustment circuitry 106, the example rendering circuitry 108, the example interface circuitry 110, the example region of focus comparator circuitry 112, the example quality level determination circuitry 114, the example client electronic device 116, the example interface circuitry 118, the example display 112, the example region of focus determination circuitry 1209, and the example sensors 124, and/or, more generally, the example workspace provider and/or the example client 104, may be implemented by hardware alone or by hardware in combination with software and/or firmware. Thus, for example, any of the example content fidelity adjustment circuitry 106, the example rendering circuitry 108, the example interface circuitry 110, the example region of focus comparator circuitry 112, the example quality level determination circuitry 114, the example client electronic device 116, the example interface circuitry 118, the example display 112, the example region of focus determination circuitry 1209, and the example sensors 124, and/or, more generally, the example workspace provider and/or the example client 104 the example Z, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example workspace provider and/or the example client 104 of FIG. 113 may include one or more elements, processes, and/or devices in addition to, or instead of, those illustrated in FIG. 1B, and/or may include more than one of any or all of the illustrated elements, processes and devices.

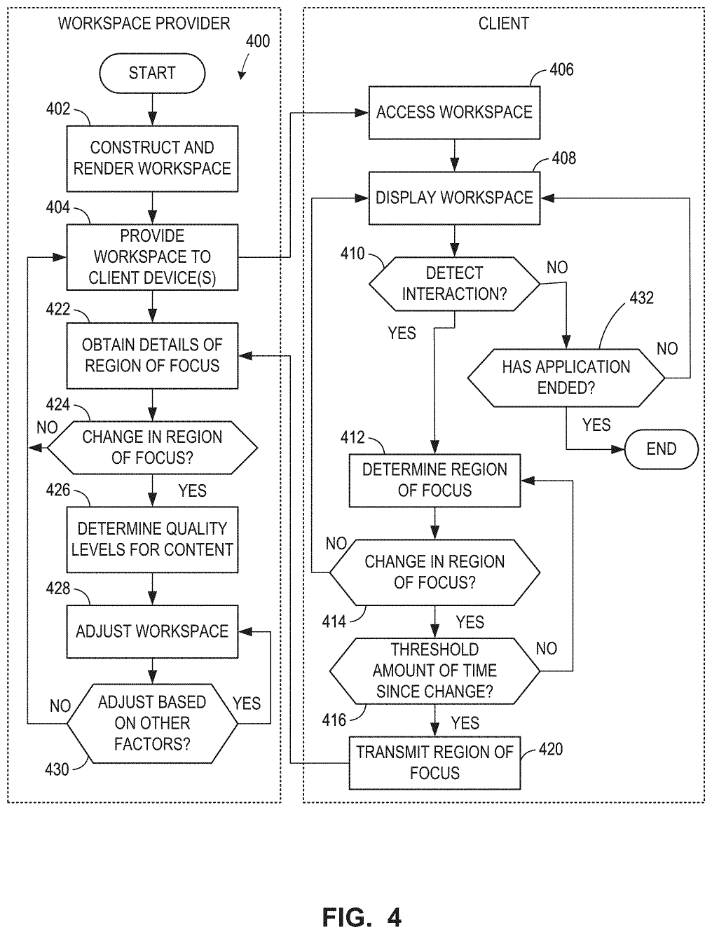

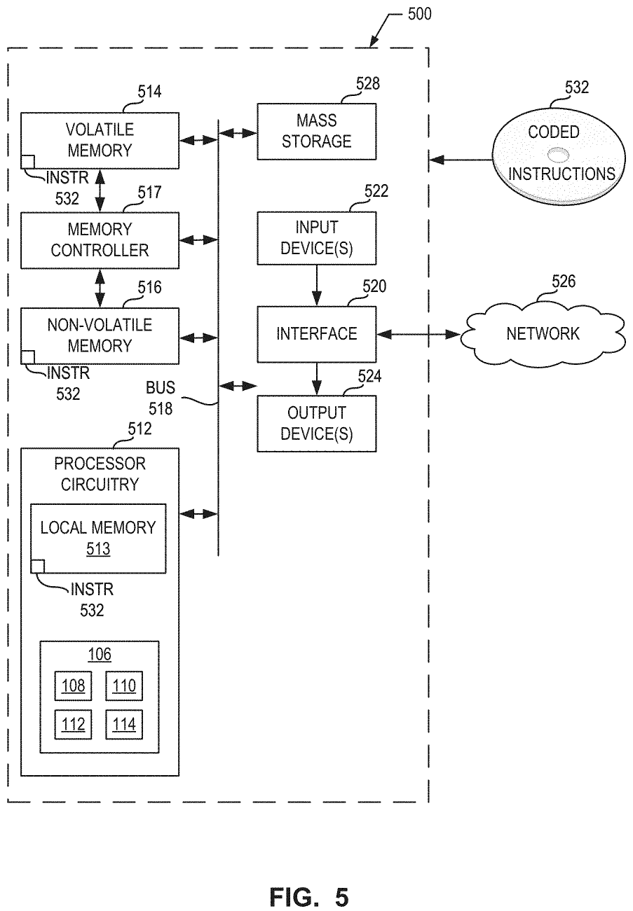

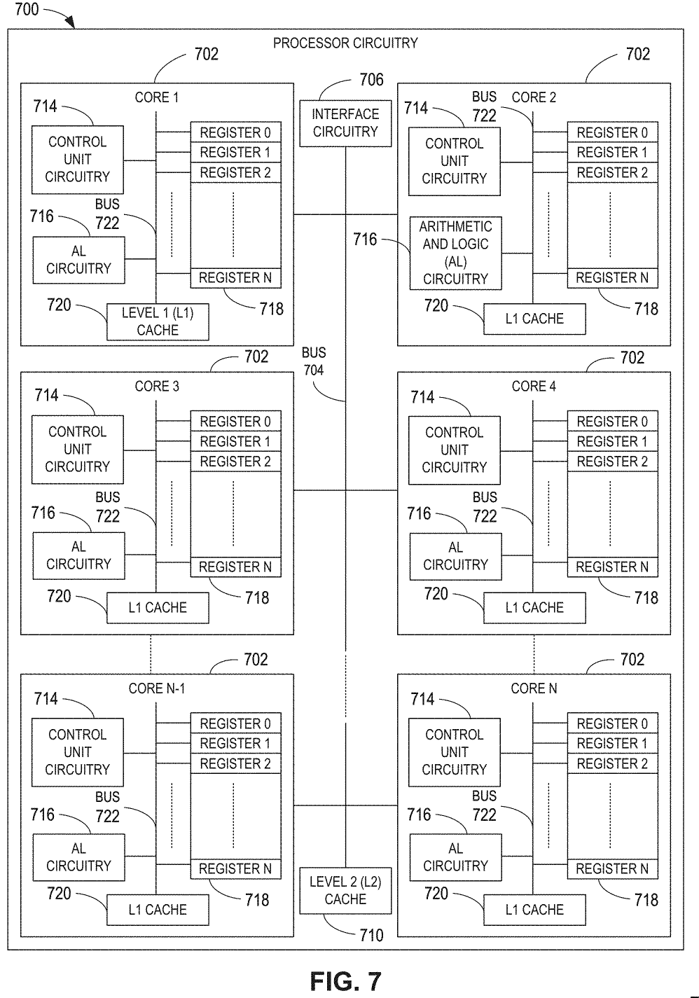

A flowchart representative of example hardware logic circuitry, machine readable instructions, hardware implemented state machines, and/or any combination thereof for implementing the workspace provider and the client 104 of FIG. 1B is shown in FIG. 4. The machine readable instructions may be one or more executable programs or portion(s) of an executable program for execution by processor circuitry, such as the processor circuitry 512, 612 shown in the example processor platforms 500, 600 discussed below in connection with FIGS. 5 and/or 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 4, many other methods of implementing the example workspace provider and/or the example client 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to adjust content fidelity in workspaces. The machine readable instructions and/or the operations 400 in the rendering circuitry 108 of the content fidelity adjustment circuitry 106 constructing and rendering a workspace (block 402). The interface circuitry 110 of the content fidelity adjustment circuitry 106 provides, transmits, and makes available the workspace to one or more clients 104 (block 404). Though many clients 104 may receive the workspace or portion of the workspace, the example of FIG. 4 will be described from the perspective of one client 104.

The interface circuitry 118 of the client electronic device 116 of the client 104 accesses, obtains, and/or receives the workspace (block 406). The display 122 presents the workspace to the user (block 408). The one or more sensors 124 detect if there is user interaction with the client electronic device 116 (block 410). The user interaction may include a user presence, an eye gaze, and well as input into the client electronic device 116. If the one or more sensor(s) 124 determines that there is user interaction (block 410: YES), the region of focus determination circuitry 120 determines a region of focus (block 412). The region of focus is the region of the workspace on which the user attention is focused.

In some examples, the region of focus determination circuitry 120 determines if there is a change in the region of focus (block 414). In some examples, if there is no change in the region of focus (block 414: NO), the example instructions 400 continue with the display 122 presenting the workspace to the user (block 408). In some examples, if there is a change in the region of focus (bock 414: YES), the region of focus determination circuitry 120 determines if a threshold amount of time has passed since the change in the region of focus (block 416). If there has not been a threshold amount of time since the change in the region of focus (block 416: NO), the example instructions continue with the region of focus determination circuitry 120 determining a region of focus (block 412). If there has been a threshold amount of time since the change in the region of focus (block 416: YES), the client electronic device 116 via the interface circuitry 118 transmits the region of focus to the content fidelity adjustment circuitry 106 of the workspace provider 102 (block 420).

The interface circuitry 110 of the content fidelity adjustment circuitry 106 receives, accesses, or obtains notifications or other details of the region of focus from the client 104 (block 422). The region of focus comparator circuitry 112 determines if there is a change in the region of focus (block 424). In some examples, as noted above if there is no change in the region of focus, no notification would have been transmitted to the workspace provider 102. In other examples, the determination of a change in the region of occurs at the workspace provider 102. Additionally or alternatively, in some examples, the workspace provider 102 and the client 104 both determine if there are changes in the region of focus. In such examples, the region of focus comparator circuitry 112 verifies or validates the determination of the region of focus determination circuitry 120.

If the region of focus comparator circuitry 112 determines that there is no change in the region of focus (block 424: NO), the example instructions 400 continue with the content fidelity adjustment circuitry 106 providing the workspace to one or more clients 104 (block 404). If the region of focus comparator circuitry 112 determines that there is a change in the region of focus (block 424: YES), the quality level determination circuitry 114 determines quality levels for different regions of content in the workspace (block 426). For example, the quality level determination circuitry 114 determines that content in the region of focus is to be presented at a higher quality level than content outside of the region of focus.

The rendering circuitry 108 adjusts the workspace in accordance with the quality levels determined by the quality level determination circuitry 114 (block 428). The content fidelity adjustment circuitry 106 determines if the content should be adjusted based on other factors (block 430). For example, content may be adjusted to a different quality level based on a time day. In some examples, content may be adjusted based on user preferences, user needs, user abilities, etc. In some examples, content may be adjusted based on the environment of the client 104. For example, content may be presented at a louder volume in a busy environment. In other examples, content may be presented at a lower nightness in a dark environment.

If the content fidelity adjustment circuitry 106 determines that the content should be adjusted based on other factors (block 430: YES), the rendering circuitry 108 adjusts the workspace (block 428). If the content fidelity adjustment circuitry 106 determines that the content is not to be further adjusted based on other factors (block 430: NO), the example instructions 400 continue with the content fidelity adjustment circuitry 106 providing the workspace to one or more clients 104 (block 404).

On the client side, if there is no user interaction (block 410: NO), the client electronic device 116 determines if the application or program presenting the workspace has ended (block 432). If the application has not ended (block 432: NO), the example instructions 400 continue with the display 122 presenting the workspace to the user (block 408). If the application presenting the workspace has ended (block 432: YES), the example instructions 400 end.

FIG. 5 is a block diagram of an example processor platform 500 structured to execute and/or instantiate the machine readable instructions and/or the operations of FIG. 4 to implement the workspace provider 102 of FIG. 1B. The processor platform 500 can be, for example, a server, a personal computer, a workstation, a self-learning machine (e.g., a neural network), a mobile device (e.g., a cell phone, a smart phone, a tablet such as an iPad™), or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the content fidelity adjustment circuitry 106, the rendering circuitry 108, the interface circuitry 110, the region of focus comparator circuitry 112, and the quality level determination circuitry 114.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 532, which may be implemented by the machine readable instructions of FIG. 4, may be stored in the mass storage device 528, in the volatile memory 514, in the non-volatile memory 516, and/or on a removable non-transitory computer readable storage medium such as a CD or DVD.

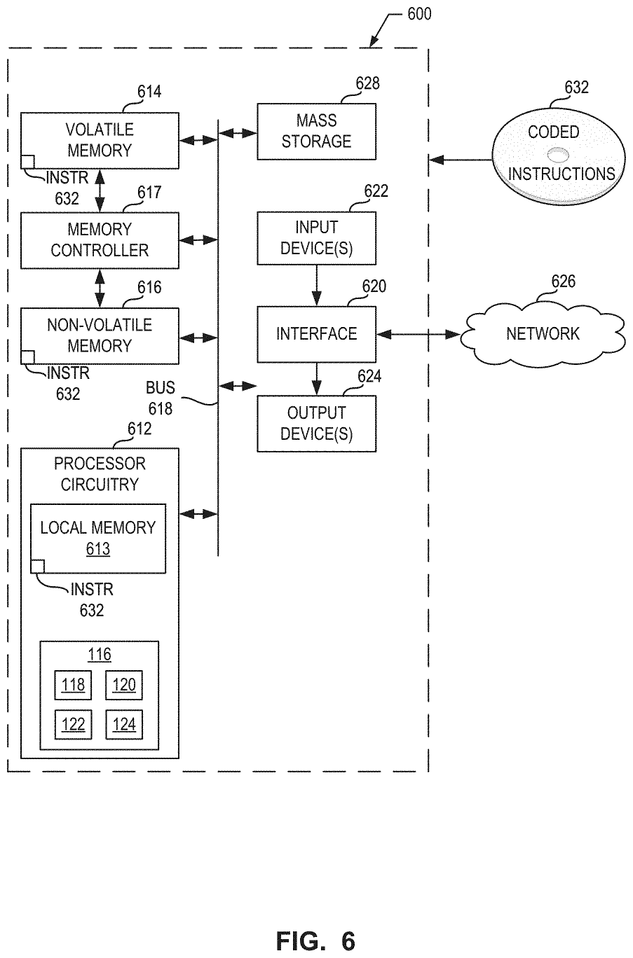

FIG. 6 is a block diagram of an example processor platform 600 structured to execute and/or instantiate the machine readable instructions and/or the operations of FIG. 4 to implement the client 104 of FIG. 1B. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the client electronic device 116, the interface circuitry 118, the region of focus determination circuitry 120, the display 122, and the sensors 124.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by SDRAM, DRAM, RDRAM®, and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a USB interface, a Bluetooth® interface, an NFC interface, a PCI interface, and/or a PCIe interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., an LED, an OLED, an LCD, a CRT display, an IPS display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a DSL connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, RAID systems, solid state storage devices such as flash memory devices and/or SSDs, and DVD drives.

The machine executable instructions 632, which may be implemented by the machine readable instructions of FIG. 4, may be stored in the mass storage device 628, in the volatile memory 614, in the non-volatile memory 516, and/or on a removable non-transitory computer readable storage medium such as a CD or DVD.

FIG. 7 is a block diagram of an example implementation of the processor circuitry 512 of FIG. 5 and/or the processor circuitry 612 of FIG. 6. In this example, the processor circuitry 512 of FIG. 5 and/or the processor circuitry 612 of FIG. 6 is implemented by a general purpose microprocessor 700. The general purpose microprocessor circuitry 700 executes some or all of the machine readable instructions of the flowchart of FIG. 4 to effectively instantiate the circuitry of FIG. B as logic circuits to perform the operations corresponding to those machine readable instructions. In some such examples, the circuitry of FIG. 1B is instantiated by the hardware circuits of the microprocessor 700 in combination with the instructions. For example, the microprocessor 700 may implement multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 4.

The cores 702 may communicate by a first example bus 704. In some examples, the first bus 704 may implement a communication bus to effectuate communication associated with one(s) of the cores 702. For example, the first bus 704 may implement at least one of an Inter-Integrated Circuit (I2C) bus, a Serial Peripheral Interface (SPI) bus, a PCI bus, or a PCIe bus. Additionally or alternatively, the first bus 704 may implement any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2_cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 514, 516 of FIG. 5 and/or 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the L1 cache 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may implement at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

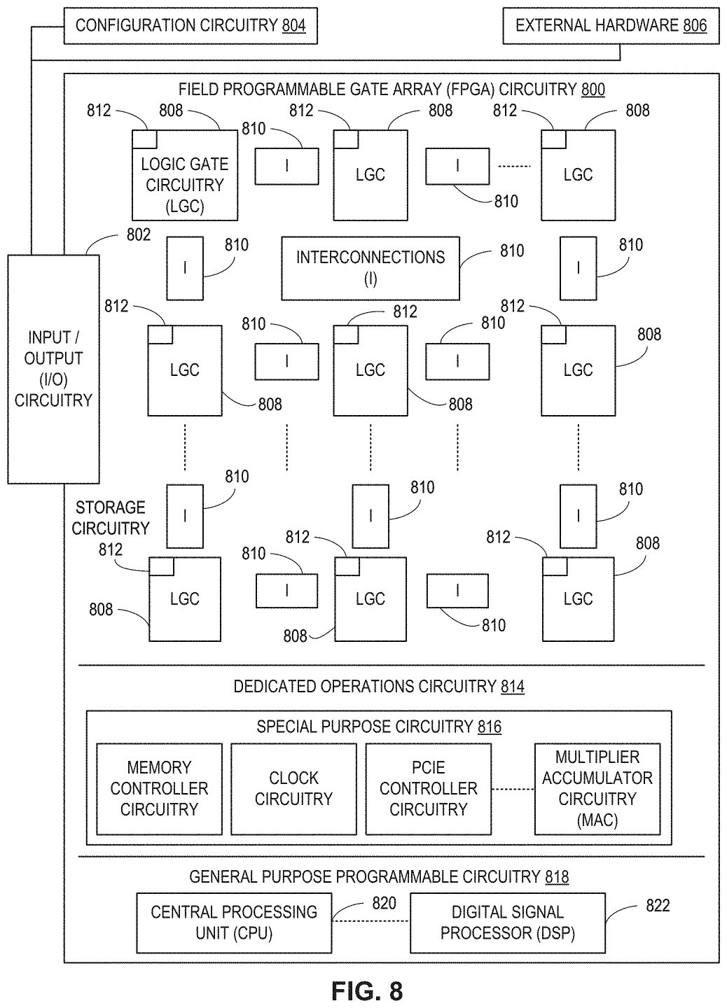

FIG. 8 is a block diagram of another example implementation of the processor circuitry 512 of FIG. 5 and/or the processor circuitry 612 of FIG. 6. In this example, the processor circuitry 512 and/or 612 is implemented by FPGA circuitry 800. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor_00 of FIG. 5 described above (which is a general purpose device that may be programmed to execute some or all of the machine readable instructions represented by the flowchart of FIG. 4 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIG. 4. In particular, the FPGA 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIG. 4. As such, the FPGA circuitry 800 may be structured to effectively instantiate some or all of the machine readable instructions of the flowchart of FIG. 4 as dedicated logic circuits to perform the operations corresponding to those software instructions in a dedicated manner analogous to an ASIC. Therefore, the FPGA circuitry 800 may perform the operations corresponding to the some or all of the machine readable instructions of FIG. 4 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware (e.g., external hardware circuitry) 806. For example, the configuration circuitry 804 may implement interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may implement the microprocessor 700 of FIG. 7. The FPGA circuitry 800 also includes an array of example logic gate circuitry 808, a plurality of example configurable interconnections 810, and example storage circuitry 812. The logic gate circuitry 808 and interconnections 810 are configurable to instantiate one or more operations that may correspond to at least some of the machine readable instructions of FIG. 4 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 6 illustrate two example implementations of the processor circuitry 512 of FIG. 5 and/or 612 of FIG. 6, many other approaches are contemplated. For example, as mentioned above, modern FPGA circuitry may include an on-board CPU, such as one or more of the example CPU 820 of FIG. 8. Therefore, the processor circuitry 512 of FIG. 5 and/or the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIG. 4 may be executed by one or more of the cores 702 of FIG. 7, a second portion of the machine readable instructions represented by the flowchart of FIG. 4 may be executed by the FPGA circuitry 800 of FIG. 8, and/or a third portion of the machine readable instructions represented by the flowchart of FIG. 4 may be executed by an ASIC. It should be understood that some or all of the circuitry of FIG. 1B may, thus, be instantiated at the same or different times. Some or all of the circuitry may be instantiated, for example, in one or more threads executing concurrently and/or in series. Moreover, in some examples, some or all of the circuitry of FIG. 1B may be implemented within one or more virtual machines and/or containers executing on the microprocessor.

In some examples, the processor circuitry 512 of FIG. 5 and/or the processor circuitry 612 of FIG. 6 may be in one or more packages. For example, the processor circuitry 700 of FIG. 7 and/or the FPGA circuitry 800 of FIG. 8 may be in one or more packages. In some examples, an XPU may be implemented by the processor circuitry 512 of FIG. 5 and/or the processor circuitry 612 of FIG. 6, which may be in one or more packages. For example, the XPU may include a CPU in one package, a DSP in another package, a GPU in yet another package, and an FPGA in still yet another package.

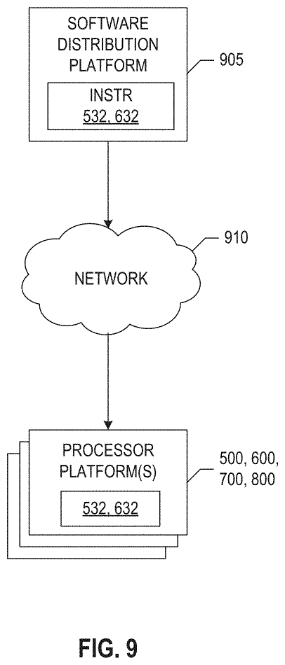

A block diagram illustrating an example software distribution platform 905 to distribute software such as the example machine readable instructions 532 of FIG. 5 and/or 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 532 of FIG. 5 and/or 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 532, 632, which may correspond to the example machine readable instructions 400 of FIG. 4, as described above. The one or more servers of the example software distribution platform 905 are in communication with a network 910, which may correspond to any one or more of the Internet, the network 105, and/or any of the other example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532, 632 from the software distribution platform 905. For example, the software, which may correspond to the example machine readable instructions 400 of FIG. 4, may be downloaded to the example processor platform 400, which is to execute the machine readable instructions 532, 632 to implement the workspace provider 102 and/or client 104. In some example, one or more servers of the software distribution platform 905 periodically offer, transmit, and/or force updates to the software (e.g., the example machine readable instructions 532 of FIG. 5 and/or 632 of FIG. 6) to ensure improvements, patches, updates, etc., are distributed and applied to the software at the end user devices.

From the foregoing, it will be appreciated that example systems, methods, apparatus, and articles of manufacture have been disclosed that adjust content fidelity based on user interaction. The examples disclosed herein provide an optimization to cloud-based collaboration tools (applicable to general cloud-based collaboration tools as well) to reduce bandwidth and increase system performance by leveraging user behavior and interaction patterns to drive a more intelligent and dynamic QoS requirement of cloud-based applications and microservices. The examples of this disclosure improve the user experience by reducing the lag seen in cloud-based applications, while improving the system performance and reducing power needs. Furthermore, the examples disclosed herein can optimize demand for power within the hosting cloud center. Thus, the disclosed systems, methods, apparatus, and articles of manufacture improve the efficiency of using a computing device. Therefore, the disclosed systems, methods, apparatus, and articles of manufacture are accordingly directed to one or more improvement(s) in the operation of a machine such as a computer or other electronic and/or mechanical device.

Examples methods, apparatus, systems, and articles of manufacture are disclosed for content fidelity adjustment based on user interaction. Example 1 is an apparatus that includes processor circuitry to execute the instructions to: determine, based on user interaction, a region of focus on a display presenting a plurality of microservices; identify a first set of the microservices presented in the region of focus; present the first set of the microservices with a first quality level; identify a second set of the microservices presented outside of the region of focus; and present the second set of the microservices with a second quality level, the second quality level lower than the first quality level.

Example 2 includes the apparatus of Example 1, wherein the first set of the microservices includes at least one microservice.

Example 3 includes the apparatus of Examples 1 or 2, wherein the first quality level is in focus and the second quality level is out of focus.

Example 4 includes the apparatus of any of Examples 1-3, wherein the first quality level is a first refresh rate and the second quality level is a second refresh rate, the second refresh rate less frequent than the first refresh rate.

Example 5 includes the apparatus of any of Examples 1-4,wherein the first quality level is an audible volume and the second quality level is mute.

Example 6 includes the apparatus of any of Examples 1-5, wherein the first quality level is a first brightness level and the second quality level is a second brightness level, the second brightness level less than the first brightness level.

Example 7 includes the apparatus of any of Examples 1-6, wherein the region of focus is a first region of focus and the processor circuitry is to: determine a change from the first region of focus to a second region of focus; change a first presentation of at least one microservice in the first set of the microservices from the first quality level to the second quality level; and change a second presentation of at least one microservice in the second set of the microservices from the second quality level to the first quality level.

Example 8 includes the apparatus of any of Examples 1-7, wherein the processor circuitry is to: perform a confirmation of the change from the first region of focus to the second region of focus after an amount of time; and proceed with the change of the first presentation and the second presentation after the amount of time.

Example 9 includes the apparatus of any of Examples 1-8, wherein the user interaction is one or more of a presence of a user, a position of a head, or an eye gaze.

Example 10 includes the apparatus of any of Examples 1-9, wherein the user interaction is one or more of typing, a movement of a mouse, a hover of a cursor, a touch, a verbal command, a voice stream, a zooming, or a click.

Example 11 includes the apparatus of any of Examples 1-10, wherein the processor circuitry includes one or more of: at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to the instructions, and one or more registers to store a result of the one or more first operations; a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry (ASIC) including logic gate circuitry to perform one or more third operations.

Example 12 includes a system that includes memory; instructions; and processor circuitry to execute the instructions to: render a workspace for display on one or more client devices; transmit the workspace to a first client device of the one or more client devices; obtain notification of a region of focus on a display of the first client device presenting the workspace; set a first quality level for first content in the region of focus; set a second quality level for second content outside of the region of focus, the second quality level lower than the first quality level; render the workspace as an adjusted workspace with the first quality level and the second quality level; and provide the adjusted workspace for the first client device.

Example 13 includes the system of Example 12, wherein the processor circuitry is to: transmit a first amount of data to transmit the workspace; and transmit a second amount of data to transmit the adjusted workspace, the second amount less than the first amount.

Example 14 includes the system of Examples 12 or 13, wherein the notification is a first notification, the region of focus is a first region of focus, the adjusted workspace is a first adjusted workspace, and the processor circuitry is to: transmit the workspace to a second client device of the one or more client devices; obtain a second notification of a second region of focus on a display of the second client device presenting the workspace; set a third quality level for third content in the second region of focus; set a fourth quality level for fourth content outside of the second region of focus, the fourth quality level lower than the third quality level; render the workspace as a second adjusted workspace with the third quality level and the fourth quality level; and provide the second adjusted workspace for the second client device.

Example 15 includes the system of Example 14, wherein the third quality level and the first quality level are the same.

Example 16 includes the system of Examples 14 or 15, wherein the first region of focus is of a first region of the workspace, and the second region of focus is of a second region of the workspace, the second region different than the first region.

Example 17 includes the system of any of Examples 14-16, wherein the workspace or the first adjusted workspace is to be displayed on the display of the first client device at the same time as the workspace or the second adjusted workspace is to be displayed on the display of the second client device.

Example 18 includes the system of any of Examples 12-17, wherein the first quality level is in focus and the second quality level is out of focus.

Example 19 includes the system of any of Examples 12-18, wherein the first quality level is a first refresh rate and the second quality level is a second refresh rate, the second refresh rate less frequent than the first refresh rate.

Example 20 includes the system of any of Examples 12-19, wherein the first quality level is a first volume level and the second quality level is a second volume level, the second volume level lower than the first volume level.

Example 21 includes the system of any of Examples 12-20, wherein the first quality level is a first brightness level and the second quality level is a second brightness level, the second brightness level less than the first brightness level.

Example 22 includes the system of any of Examples 12-21, wherein the processor circuitry is to render the workspace as the adjusted workspace based on a time of day.

Example 23 includes the system of any of Examples 12-22, wherein the processor circuitry includes one or more of: at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to the instructions, and one or more registers to store a result of the one or more first operations; a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry (ASIC) including logic gate circuitry to perform one or more third operations.

Example 24 includes a non-transitory machine readable media comprising instructions that, when executed, cause one or more processors to at least: determine, based on user interaction, a region of focus on a display presenting a plurality of microservices; identify a first set of the microservices presented in the region of focus; present the first set of the microservices with a first quality level; identify a second set of the microservices presented outside of the region of focus; and present the second set of the microservices with a second quality level, the second quality level lower than the first quality level.

Example 25 includes the machine readable media of Example 24, wherein the first set of the microservices includes at least one microservice.

Example 26 includes the machine readable media of Examples 24 or 25, wherein the first quality level is in focus and the second quality level is out of focus.

Example 27 includes the machine readable media of any of Examples 24-26, wherein the first quality level is a first refresh rate and the second quality level is a second refresh rate, the second refresh rate less frequent than the first refresh rate.

Example 28 includes the machine readable media of any of Examples 24-27, wherein the first quality level is an audible volume and the second quality level is mute.

Example 29 includes the machine readable media of any of Examples 24-28, wherein the first quality level is a first brightness level and the second quality level is a second brightness level, the second brightness level less than the first brightness level.

Example 30 includes the machine readable media of any of Examples 24-29, wherein the region of focus is a first region of focus and the instructions cause the one or more processors to: determine a change from the first region of focus to a second region of focus; change a first presentation of at least one microservice in the first set of the microservices from the first quality level to the second quality level; and change a second presentation of at least one microservice in the second set of the microservices from the second quality level to the first quality level.

Example 31 includes the machine readable media of Example 30, wherein the instructions cause the one or more processors to: perform a confirmation of the change from the first region of focus to the second region of focus after an amount of time; and proceed with the change of the first presentation and the second presentation after the amount of time.

Example 32 includes the machine readable media of any of Examples 24-31, wherein the user interaction is one or more of a presence of a user, a position of a head, or an eye gaze.

Example 33 includes the machine readable media of any of Examples 24-32, wherein the user interaction is one or more of typing, a movement of a mouse, a hover of a cursor, a touch, a verbal command, a voice stream, a zooming, or a click.

Example 34 includes a non-transitory machine readable media comprising instructions that, when executed, cause one or more processors to at least: render a workspace for display on one or more client devices; transmit the workspace to a first client device of the one or more client devices; obtain notification of a region of focus on a display of the first client device presenting the workspace; set a first quality level for first content in the region of focus; set a second quality level for second content outside of the region of focus, the second quality level lower than the first quality level; render the workspace as an adjusted workspace with the first quality level and the second quality level; and provide the adjusted workspace for the first client device.

Example 35 includes the machine readable media of Example 34, wherein the instructions cause the one or more processors to: transmit a first amount of data to transmit the workspace; and transmit a second amount of data to transmit the adjusted workspace, the second amount less than the first amount.

Example 36 includes the machine readable media of Examples 34 or 35, wherein the notification is a first notification, the region of focus is a first region of focus, the adjusted workspace is a first adjusted workspace, and the instructions cause the one or more processors to: transmit the workspace to a second client device of the one or more client devices; obtain a second notification of a second region of focus on a display of the second client device presenting the workspace; set a third quality level for third content in the second region of focus; set a fourth quality level for fourth content outside of the second region of focus, the fourth quality level lower than the third quality level; render the workspace as a second adjusted workspace with the third quality level and the fourth quality level; and provide the second adjusted workspace to the second client device.

Example 37 includes the machine readable media of Example 36, wherein the third quality level and the first quality level are the same.

Example 38 includes the Examples 36 or 37, wherein the first region of focus is of a first region of the workspace, and the second region of focus is of a second region of the workspace, the second region different than the first region.

Example 39 includes the machine readable media of any of Examples 36-38, wherein the workspace or the first adjusted workspace is to be displayed on the display of the first client device at the same time as the workspace or the second adjusted workspace is to be displayed on the display of the second client device.

Example 40 includes the machine readable media of any of Examples 34-39, wherein the first quality level is in focus and the second quality level is out of focus.

Example 41 includes the machine readable media of any of Examples 34-40, wherein the first quality level is a first refresh rate and the second quality level is a second refresh rate, the second refresh rate less frequent than the first refresh rate.

Example 42 includes the machine readable media of any of Examples 34-41, wherein the first quality level is a first volume level and the second quality level is a second volume level, the second volume level lower than the first volume level.

Example 43 includes the machine readable media of any of Examples 34-42, wherein the first quality level is a first brightness level and the second quality level is a second brightness level, the second brightness level less than the first brightness level.

Example 44 includes the machine readable media of any of Examples 34-43, wherein the instructions cause the one or more processors to render the workspace as the adjusted workspace based on a time of day.

Example 45 includes a method of adjusting content, the method comprising: determining, by executing instructions with a processor and based on user interaction, a region of focus on a display presenting a plurality of microservices; identifying, by executing instructions with the processor, a first set of the microservices presented in the region of focus; presenting, by executing instructions with the processor, the first set of the microservices with a first quality level; identifying, by executing instructions with the processor, a second set of the microservices presented outside of the region of focus; and presenting, by executing instructions with the processor, the second set of the microservices with a second quality level, the second quality level lower than the first quality level.

Example 46 includes the method of Example 45, wherein the first set of the microservices includes at least one microservice.

Example 47 includes the method of Examples 45 or 46, wherein the first quality level is in focus and the second quality level is out of focus.

Example 48 includes the method of any of Examples 45-47, wherein the first quality level is a first refresh rate and the second quality level is a second refresh rate, the second refresh rate less frequent than the first refresh rate.

Example 49 includes the machine readable media of any of Examples 45-48, wherein the first quality level is an audible volume and the second quality level is mute.

Example 50 includes the machine readable media of any of Examples 45-49, wherein the first quality level is a first brightness level and the second quality level is a second brightness level, the second brightness level less than the first brightness level.

Example 51 includes the machine readable media of any of Examples 45-50, wherein the region of focus is a first region of focus, the method further including: determining a change from the first region of focus to a second region of focus; changing a first presentation of at least one microservice in the first set of the microservices from the first quality level to the second quality level; and changing a second presentation of at least one microservice in the second set of the microservices from the second quality level to the first quality level.

Example 52 includes the method of Example 51 further including: performing a confirmation of the change from the first region of focus to the second region of focus after an amount of time; and proceeding with the change of the first presentation and the second presentation after the amount of time.

Example 53 the method of any of Examples 45-52, wherein the user interaction is one or more of a presence of a user, a position of a head, or an eye gaze.

Example 54 the method of any of Examples 45-53, wherein the user interaction is one or more of typing, a movement of a mouse, a hover of a cursor, a touch, a verbal command, a voice stream, a zooming, or a click.

Example 55 includes a method of adjusting content, the method comprising: rendering, by executing instructions with a processor, a workspace for display on one or more client devices; transmitting, by executing instructions with the processor, the workspace to a first client device of the one or more client devices; obtaining, by executing instructions with the processor, notification of a region of focus on a display of the first client device presenting the workspace; setting, by executing instructions with the processor, a first quality level for first content in the region of focus; setting, by executing instructions with the processor, a second quality level for second content outside of the region of focus, the second quality level lower than the first quality level; rendering, by executing instructions with the processor, the workspace as an adjusted workspace with the first quality level and the second quality level; and providing, by executing instructions with the processor. the adjusted workspace for the first client device.

Example 56 includes the method of Example 55, further including: transmitting a first amount of data to transmit the workspace; and transmitting a second amount of data to transmit the adjusted workspace, the second amount less than the first amount.

Example 57 includes the method of Example 55 or 56, wherein the notification is a first notification, the region of focus is a first region of focus, and the adjusted workspace is a first adjusted workspace, the method further including: transmitting the workspace to a second client device of the one or more client devices; obtaining a second notification of a second region of focus on a display of the second client device presenting the workspace; setting a third quality level for third content in the second region of focus; setting a fourth quality level for fourth content outside of the second region of focus, the fourth quality level lower than the third quality level; rendering the workspace as a second adjusted workspace with the third quality level and the fourth quality level; and providing the second adjusted workspace to the second client device.

Example 58 includes the method of Example57, wherein the third quality level and the first quality level are the same.

Example 59 includes the method of Example 57 or 58, wherein the first region of focus is of a first region of the workspace, and the second region of focus is of a second region of the workspace, the second region different than the first region.

Example 60 includes the method of any of Examples 57-59, wherein the workspace or the first adjusted workspace is to be displayed on the display of the first client device at the same time as the workspace or the second adjusted workspace is to be displayed on the display of the second client device.

Example 61 includes the method of any of Examples 55-60, wherein the first quality level is in focus and the second quality level is out of focus.

Example 62 includes the method of any of Examples 55-61, wherein the first quality level is a first refresh rate and the second quality level is a second refresh rate, the second refresh rate less frequent than the first refresh rate.

Example 63 includes the method of any of Examples 55-62, wherein the first quality level is a first volume level and the second quality level is a second volume level, the second volume level lower than the first volume level.

Example 64 includes the method of any of Examples 55-63, wherein the first quality level is a first brightness level and the second quality level is a second brightness level, the second brightness level less than the first brightness level.

Example 65 includes the method of any of Examples 55-64, further including rendering the workspace as the adjusted workspace based on a time of day.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
memory;
instructions; and
processor circuitry to execute the instructions to:
determine, based on user interaction, a region of focus on a display presenting a plurality of microservices;
identify a first set of the microservices presented in the region of focus;
present the first set of the microservices with a first quality level;
identify a second set of the microservices presented outside of the region of focus; and
present the second set of the microservices with a second quality level, the second quality level lower than the first quality level.

2. The apparatus of claim 1, wherein the first set of the microservices includes at least one microservice.

3. The apparatus of claim 1, wherein the first quality level is in focus and the second quality level is out of focus.

4. The apparatus of claim 1, wherein the first quality level is a first refresh rate and the second quality level is a second refresh rate, the second refresh rate less frequent than the first refresh rate.

5. The apparatus of claim 1, wherein the first quality level is an audible volume and the second quality level is mute.

6. The apparatus of claim 1, wherein the first quality level is a first brightness level and the second quality level is a second brightness level, the second brightness level less than the first brightness level.

7. The apparatus of claim 1, wherein the region of focus is a first region of focus and the processor circuitry is to:
determine a change from the first region of focus to a second region of focus;
change a first presentation of at least one microservice in the first set of the microservices from the first quality level to the second quality level; and
change a second presentation of at least one microservice in the second set of the microservices from the second quality level to the first quality level.

8. The apparatus of claim 7, wherein the processor circuitry is to:
perform a confirmation of the change from the first region of focus to the second region of focus after an amount of time; and
proceed with the change of the first presentation and the second presentation after the amount of time.

9. The apparatus of claim 1, wherein the user interaction is one or more of a presence of a user, a position of a head, or an eye gaze.

10. The apparatus of claim 1, wherein the user interaction is one or more of typing, a movement of a mouse, a hover of a cursor, a touch, a verbal command, a voice stream, a zooming, or a click.

11. The apparatus of claim 1, wherein the processor circuitry includes one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to the instructions, and one or more registers to store a result of the one or more first operations;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations.

12. A system comprising:
memory;
instructions; and
processor circuitry to execute the instructions to:
render a workspace for display on one or more client devices;
transmit the workspace to a first client device of the one or more client devices;
obtain notification of a region of focus on a display of the first client device presenting the workspace;
set a first quality level for first content in the region of focus;
set a second quality level for second content outside of the region of focus, the second quality level lower than the first quality level;
render the workspace as an adjusted workspace with the first quality level and the second quality level; and
provide the adjusted workspace for the first client device.

13. The system of claim 12, wherein the processor circuitry is to:
transmit a first amount of data to transmit the workspace; and
transmit a second amount of data to transmit the adjusted workspace, the second amount less than the first amount.

14. The system of claim 12, wherein the notification is a first notification, the region of focus is a first region of focus, the adjusted workspace is a first adjusted workspace, and the processor circuitry is to:
transmit the workspace to a second client device of the one or more client devices;
obtain a second notification of a second region of focus on a display of the second client device presenting the workspace;
set a third quality level for third content in the second region of focus;
set a fourth quality level for fourth content outside of the second region of focus, the fourth quality level lower than the third quality level;
render the workspace as a second adjusted workspace with the third quality level and the fourth quality level; and
provide the second adjusted workspace for the second client device.

15. The system of claim 14, wherein the third quality level and the first quality level are the same.

16. The system of claim 14, wherein the first region of focus is of a first region of the workspace, and the second region of focus is of a second region of the workspace, the second region different than the first region.

17. The system of claim 14, wherein the workspace or the first adjusted workspace is to be displayed on the display of the first client device at the same time as the workspace or the second adjusted workspace is to be displayed on the display of the second client device.

18. The system of claim 12, wherein the first quality level is in focus and the second quality level is out of focus.

19. The system of claim 12, wherein the first quality level is a first refresh rate and the second quality level is a second refresh rate, the second refresh rate less frequent than the first refresh rate.

20. The system of claim 12, wherein the first quality level is a first volume level and the second quality level is a second volume level, the second volume level lower than the first volume level.

21. The system of claim 12, wherein the first quality level is a first brightness level and the second quality level is a second brightness level, the second brightness level less than the first brightness level.

22. The system of claim 12, wherein the processor circuitry is to render the workspace as the adjusted workspace based on a time of day.

23. The system of claim 12, wherein the processor circuitry includes one or more of:
at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to the instructions, and one or more registers to store a result of the one or more first operations;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrate Circuitry (ASIC) including logic gate circuitry to perform one or more third operations.

24-65. (canceled)
